(19) United States
(12) Patent Application Publication
(10) Pub. No.: US 2004/0126086 A1
(43) Pub. Date: Jul. 1, 2004

(54) Image recording apparatus

(75) Inventors: Hiroaki Nakamura, Kanagawa (JP); Toshihiko Kaku, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/669,653

(22) Filed: Sep. 25, 2003

(30) Foreign Application Priority Data
Sep. 30, 2002 (JP) 2002-285528

(51) Int. Cl. H04N 5/91; H04N 7/00

(52) U.S. Cl. 386/46

(57) ABSTRACT

There is disclosed an image recording apparatus capable of obtaining a record, in which an original image is reproducible, in the event that an image correcting processing is applied to the original image to perform a recording. The corrected image subjected to the correcting processing is recorded onto a first media. At least either one of the original image and a set of image and information capable of reproducing the original image is recorded onto a second media.

### BACKGROUND OF THE INVENTION

1. Field of the Invention

The present invention relates to an image recording apparatus for recording an image corrected through an application of a predetermined correcting processing to an original image.

2. Description of the Related Art

Hitherto, there is performed such a matter that a desired image correcting processing is applied to a photographic image data, which is obtained through a photography of a subject by a digital camera, to record corrected image data on a recording medium such as a flexible disk (hereinafter it is denoted as FD), or to print a corrected image represented by the corrected image data into a photograph. As the image correcting processing, there are raised, for example, processing of correcting red-eye and gold-eye in which a flash of a flash light emitting apparatus is reflected on a capillary inside the retina, so that eyes come out red and gold, processing of correcting shutting one's eyes by a flash, processing of correcting color of sky and skin color into preferable colors, and tone correcting processing. Usually, it is general that an operator uses a computer in a photofinishing laboratory to perform the image correcting processing. The use of a computer in the image correcting processing makes it possible that an operator may modifies inconvenience, which is considered to be undesirable as a photograph, while the operator monitors on a screen a corrected image after the image correcting processing. Recently, also in a film type of camera, there is widely performed such a matter that when a photographic print is created, a photographic image recorded on a photographic print after a photograph is optically read to obtain photographic image data, and the same image correcting processing as the above-mentioned digital camera is applied to the photographic image data to create corrected image data and the corrected image data is subjected to the photographic print and thereby creating a desired photograph. Obtaining the photographic image data through reading a photographic image printed on a photographic film not only makes it possible to perform image correcting processing on a digital basis using a computer, but also brings about such an advantage that saving of images is convenient, for example, image data is recorded into an FD. In this respect, Japanese Patent Application Laid Open Gazette Hei. 10-150538 (Page 4, Fig. FIG. 1) discloses a method in which an image is printed into a photograph, and image data representative of an image is recorded onto a recording medium such as an FD. Japanese Patent Application Laid Open Gazette Hei. 11-234514 (Page 3, FIG. FIG. 3) discloses a method in which a size of image data representative of an image is computed and a recording medium optimum for recording the image data is selected and then the image data is recorded.

By the way, for example, according to the above-mentioned red-eye correcting processing, there is performed such a matter that a computer detects an image portion of the red-eye in an image and automatically corrects the image portion. In this case, it happens that the computer erroneously recognizes an image portion, which is concerned with the red-eye, as the red-eye portion, and automatically corrects the image portion. Further, even if the red-eye portion is properly corrected, some person will feel that the non-corrected red-eye image is better. Thus, in this manner, it is not always true that a corrected image is preferable than non-corrected photographic image, and it happens that after the correction, there occurs a necessity that the photographic image before the correction is reproduced. However, according to the ways disclosed in the above-referenced Japanese Patent Application Laid Open Gazettes Hei. 10-150538 and Hei. 11-234514, it is difficult to reproduce the photographic image.

This problem is associated with not only a field of a camera, but also a field using image correcting processing generally.

### SUMMARY OF THE INVENTION

In view of the foregoing, it is an object of the present invention to provide an image recording apparatus capable of obtaining a record, in which an original image is reproducible, in the event that an image correcting processing is applied to the original image to perform a recording.

To achieve the above-mentioned objects, the present invention provides an image recording apparatus:

an image data input section that enters image data representative of an original image;

an image correcting section that applies a predetermined correcting processing to the original image represented by the image data entered through the image data input section to create corrected image; and

an image recording section that records the corrected image subjected to the correcting processing in the image correcting section onto a first external media for recording an image in form of at least either one of an image recording on a visual basis and a recording by image data, and records at least either one of a set of image and information capable of reproducing the original image and the original image a second external media for recording an image in form of at least either one of an image recording on a visual basis and a recording by image data.

According to the image recording apparatus of the present invention, the corrected image subjected to a predetermined correcting processing is recorded onto the first media, and at least either one of a set of image and information capable of reproducing the original image and the original image is recorded onto the second external media. Accordingly, for example, when it is deemed that the corrected image recorded on the first media is not preferable, it is possible to use the original image recorded on the second media as it is, or alternatively to reproduce the original image from the image and information stored in the second media, which are capable of reproducing the original image recorded on the second media.

In the image recording apparatus according to the present invention as mentioned above, it is preferable that the image correcting section applies a red-eye correcting processing to the original image.

Recently, a miniaturization of a camera advances. It is difficult for such a miniaturized camera to make sure of a sufficient distance between a flash light emission unit and a lens. This enhances a possibility of occurrence of the red-eye. Correction of the image portion of the red-eye of the original image by the image correcting section, and recording of the corrected image and the set of image and information capable of reproducing the original image makes it possible to resolve inconvenience of the red-eye, and also possible to readily reproduce the original image when it is desired to restore the corrected image to the original image.

In the image recording apparatus according to the present invention as mentioned above, it is preferable that the image data input section enters a photographic image, and the image recording section records the corrected

image into a photographic print, and records the set of image and information onto a medium for recording digital data.

In the field of a digital camera, there becomes widespread such a service that a photographic image is printed into photograph in accordance with photographic image data recorded on a small type of recording medium and the photographic image data is recorded onto an FD. It is desirable that the printed photograph is subjected to a correcting processing in which special know-how and the like are reflected. On the other hand, the photographic image data recorded on the FD corresponds to a photographic film of a film type of camera, and it is preferable that the photographic image data is accessible by a user.

Further, in the image recording apparatus according to the present invention as mentioned above, it is acceptable that the image data input section enters a photographic image, and

the image recording section records the corrected image into a first photographic print, and records at least either one of, the set of image and information and the original image into a second photographic print.

For example, in the event that the original image not corrected is recorded onto an FD, no use of a personal computer and the like makes it difficult to confirm the original image recorded on the FD. Recording both the corrected image and the original image into photographic print makes it possible for a person having no personal computer to obtain both the photographs and thereby selecting a preferable photograph.

### BRIEF DESCRIPTION OF THE DRAWINGS

FIG. 1 is a perspective view of a digital printer for a photography to which an image recording apparatus according to an embodiment of the present invention is applied.

FIG. 2 is a typical illustration of a scanner section 110 of an image-input machine 100.

FIG. 3 is a block diagram of a circuit section 160 of an image correcting processing section 120 of the image-input machine 100.

FIG. 4 is a typical illustration of an internal structure of an image output machine 200.

FIG. 5 is a functional block diagram of an image correcting processing substrate 190.

FIG. 6 is a functional block diagram of an image correcting processing substrate 195.

### DETAILED DESCRIPTION OF PREFERRED EMBODIMENTS

Embodiments of the present invention will be described with reference to the accompanying drawings.

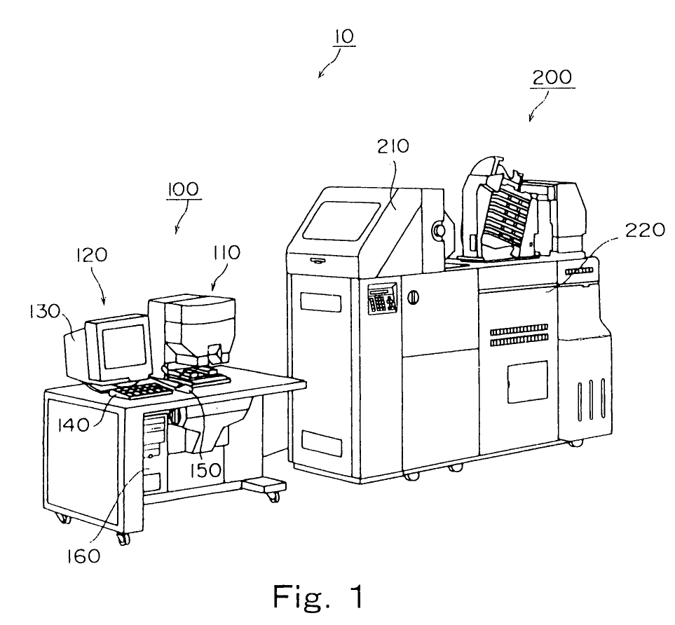

FIG. 1 is a perspective view of a digital printer for a photography, wherein an image is printed on a photographic basis in accordance with digital image data, to which an image recording apparatus according to an embodiment of the present invention is applied.

A photographic digital printer 10 is an apparatus in which a photographic image recorded on a photographic film is optically read to obtain photographic image data, or photographic image data recorded on a small type of recording medium through taking a photograph by a digital camera and the like is read from the small type of recording medium, so that the photographic image data is subjected to a predetermined correcting processing to create corrected image data, and the corrected image data and corrected image based on the corrected image data are recorded into an FD and a photographic print. The photographic digital printer 10 comprises an image input machine 100 and an image output machine 200.

The image input machine 100 is provided with a scanner section 110 for sequentially reading a plurality of photographic images recorded on a developed photographic film on a photoelectric basis for each frame to obtain photographic image data, and an image correcting processing section 120 for applying a predetermined correcting processing to the photographic image data obtained through reading by the scanner section 110. The image correcting processing section 120 comprises a CRT display section 130, a keyboard 140, a mouse 150, and a circuit section 160. The circuit section 160 has on the outside appearance a small type of recording medium mounting slot (not illustrated) for mounting a small type of recording medium and a FD mounting slot (not illustrated) for mounting an FD. The circuit section 160 comprises a computer circuit section constituting a computer system together with the CRT display section 130, the keyboard 140, and the mouse 150, and an image correcting processing substrate, which is a hardware for image correcting processing. Details of the respective sections of the image input machine 100 will be described later.

The image output machine 200 comprises a laser printer section 210 for scanning a laser beam modulated in accordance with image data obtained by the image input machine 100 to expose an image onto a photographic paper, and a processor section 220 for developing the photographic paper exposed by the laser printer section 210 to obtain a printed photograph. Details of the respective sections of the image output machine 200 will be described later.

First, there will be explained a structure of the scanner section 110 of the image-input machine 100 and a series of procedures of reading a photographic image recorded on a photographic film.

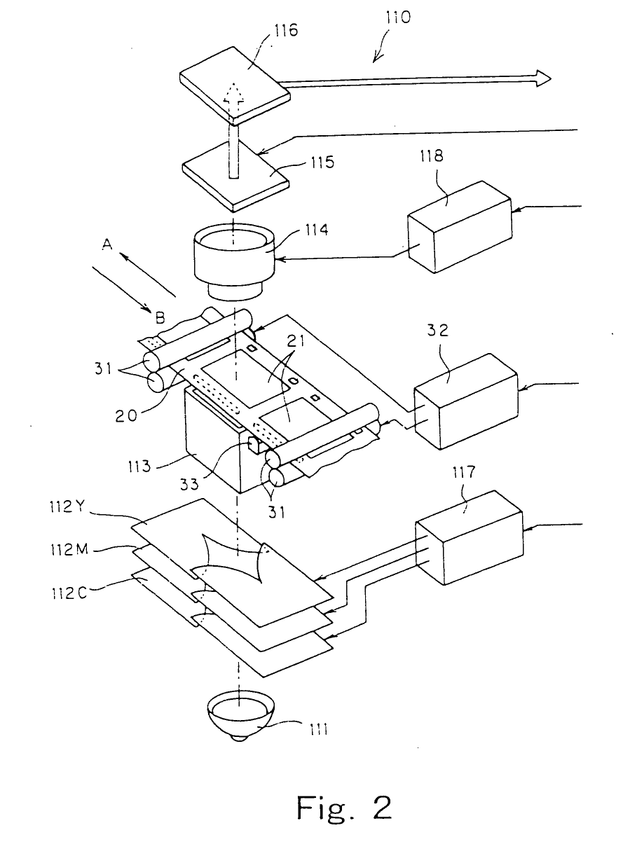

FIG. 2 is a typical illustration of a scanner section 110 of an image-input machine 100.

Here, a developed photographic film 20 is set to a film carrier (not illustrated) having feeding rollers 31 and a feed driving section 32, and the feeding rollers 31 are driven by the feed driving section 32 so that the photographic film 20 is fed in an arrow A direction to roughly read at high speed the photographic image recorded on the photographic film for each frame (hereinafter, this is referred to as a pre-scanning).

The scanner section 110 is provided with a light source 111 consisting of, for example, a halogen lamp or a metal halide lamp. The light emitted from the light source 111 irradiates the photographic film 20, as shown in FIG. 2, via three filters 112C, 112M and 112Y, which filter lights of cyan (C), magenta (M) and yellow (Y), respectively, and further via a diffusion box 113. The lights penetrated the photographic film 20 reach a CCD photosensor 115 via a zoom lens 114. The effect of the zoom lens 114 forms the photographic image recorded on the photographic film 20 on a plane including a sensor plane of the CCD photosensor 115.

A photographic image signal obtained in the CCD photosensor 115 is converted into digital photographic image data by an A/D converter 116 and then transmitted to a circuit section 160 which will be described later.

Each of the three filters 112C, 112M and 112Y has at the center an aperture section through which light passes independent of an effect of the filter, wherein light effected by the filter penetrates the periphery of the aperture section. A filter control section 117 controls sizes of the aperture sections of the filters, and thereby controlling the effects of the filters. Lights penetrated the three filters 112C, 112M and 112Y are diffused in the diffusion box 113 into uniform lights so as to irradiate the photographic film 20.

The zoom lens 114 forms the photographic image on the photographic film 20 on a surface of the CCD photosensor 115. The zoom lens 114 is driven by a zoom lens driving section 118 to control a focal length of the zoom lens 114, so that an image of a magnification according to the focal length of the zoom lens 114 is formed on the sensor surface of the CCD photosensor 115. The CCD photosensor 115 is a line sensor in which a large number of photocells are disposed in a width direction of the photographic film 20. Such a type of line sensor is arranged in three lines in a feeding direction of the photographic film 20. On surfaces of those line sensors, there are disposed color separation filters of red, green and blue, respectively, so that those line sensors read the associated components of red, green and blue of the photographic image recorded on the photographic film 20, respectively. An image reading by the three line sensors is repeatedly carried out while the photographic film 20 is carried in an A-direction or a B-direction, so that the photographic image recorded on the photographic film 20 on a two-dimensional basis is read for each frame.

In a pre-scanning wherein the photographic film 20 is carried in the A-direction so that the CCD photosensor 115 performs image reading, a feeding speed of the photographic film 20 is fast. And in the line sensors constituting the CCD photosensor 115, the image reading is carried out with only the photocells thinned out, so that a rough image is obtained.

At the time of the pre-scanning, the three filters 112C, 112M and 112Y are each controlled to have a predetermined size of aperture. After the pre-scanning, the read photographic image and a condition designation screen prepared beforehand are displayed on the CRT display section 130 shown in FIG. 1. An operator confirms the photographic image and the condition designation screen displayed on the CRT display section 130, and designates image obtaining conditions such as a print size, image density and densities for colors of C, M and Y. When the image obtaining conditions are designated, the three filters 112C, 112M and 112Y are controlled to meet the designated image obtaining conditions, and as the need arises, the zoom lens 114 is adjusted to a focal length according to the designated print size. And the photographic film 20 is carried in the B-direction so that the CCD photosensor 115 performs image reading in a thinning way (or without thinning) according to the designated print size (hereinafter this is referred to as a fine scanning). The photographic image signal obtained in the CCD photosensor 115 is, as mentioned above, converted into the digital photographic image data by the A/D converter 116 and then transmitted to the circuit section 160.

Next, there will be described the structure of the circuit section 160 constituting the image correcting processing section 120 of the image-input machine 100.

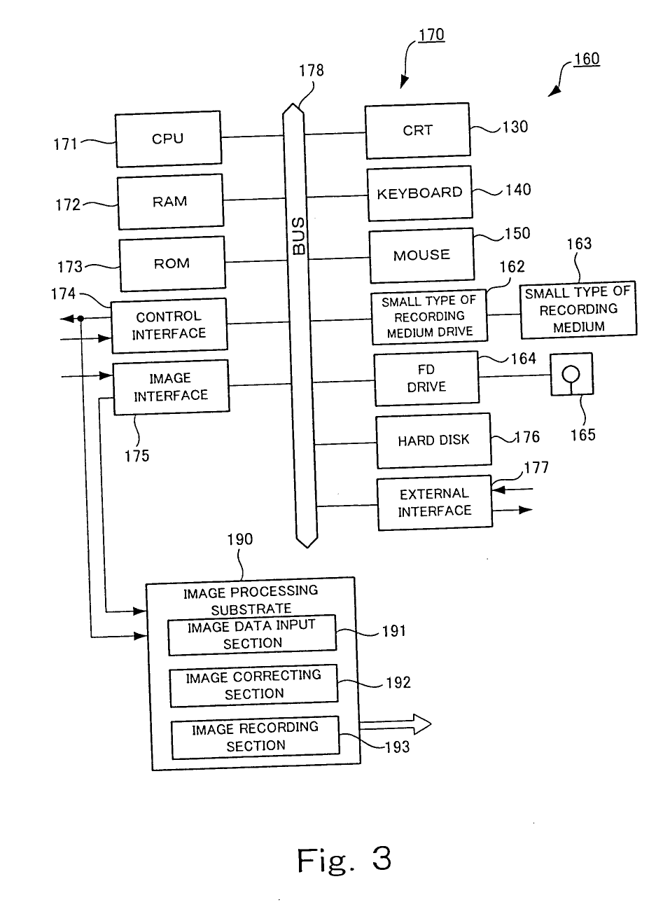

FIG. 3 is a block diagram of the circuit section 160 of the image correcting processing section 120 of the image-input machine 100.

The circuit section 160 comprises a computer circuit section 170 and an image correcting processing substrate 190.

The computer circuit section 170 comprises: a CPU (central processing unit) 171 for executing various sorts of programs; a RAM 172 that is used as a working area when the various sorts of programs are executed in the CPU (central processing unit) 171; a ROM 173 for storing fixed constants and the like; a control interface 174 for inputting and outputting control signals to control respective sections of the image-input machine 100; an image interface 175 for receiving an image from the scanner section 110 shown in FIG. 2 and outputting the image to the image correcting processing substrate 190; a CRT display unit 130 as shown in FIG. 1; a keyboard 140; a mouse 150; a small type of recording medium drive 162 for accessing a small type of recording medium 163; an FD (flexible disk) drive 164 for accessing an FD (flexible disk) 165; a hard disk 176; and an exterior interface 177 for transmission and receipt of data between the circuit section 160 and the image output machine 200 shown in FIG. 1. Those elements are connected to one another via a bus 178.

The control interface 174 sends control signals to the feed driving section 32, the filter control section 117, and the zoom lens driving section 118 shown in FIG. 2. The feed driving section 32, the filter control section 117, and the zoom lens driving section 118 receive the associated control signals to perform a feed of the photographic film 20, a control of the filters 112C, 112M and 112Y, and an adjustment of the focal length of the zoom lens 114 (an adjustment of the image forming magnification).

The control interface 174 further sends control signals to control the CCD photosensor 115, and control signals to control the respective sections of the image-input machine 100.

The control interface 174 transmits image obtaining conditions, which are designated by an operator, to the image correcting processing substrate 190.

The image correcting processing substrate 190 comprises: an image data input section 191 for entering photographic image data obtained in the scanner section 110 or photographic image data stored in the small type of recording medium 163; an image correcting section 192 for applying a predetermined image correcting processing to the photographic image data entered through the image data input section 191 to create corrected image data; and an image recording section 193 for transmitting corrected image based on the corrected image data created in the image correcting section 192 to the FD 165 or the image output machine 200 shown in FIG. 1 to record into a photograph. The image data input section 191 corresponds to an example of the image data input section of the image recording apparatus according to the present invention. The image correcting section 192 corresponds to an example of the image correcting section of the image recording apparatus according to the present invention. The image recording section 193 corresponds to an example of the image recording section of the image recording apparatus according to the present invention. There will be described the processing of the image correcting processing substrate 190.

The image-input machine 100 is basically constructed as mentioned above.

In the event that the image-input machine 100 shown in FIG. 1 reads a photographic image recorded on the photographic film, when the scanner section 110 performs the pre-scanning, the photographic image obtained by the pre-scanning is fed via the image interface 175 to the computer circuit section 170 (cf. FIG. 3) of the circuit section 160 and is displayed on the CRT display section 130. When an operator designates image obtaining condition, information representative of the image obtaining condition according to the designated image obtaining condition is transmitted to the image correcting processing substrate 190 (cf. FIG. 3). And further the scanner section 110 performs the fine-scanning, so that the photographic image thus obtained is fed to the image correcting processing substrate 190 and is subjected to various sorts of correcting processing. Correcting image after the correcting processing is transmitted to the image output machine 200 and is used as a signal for the laser beam modulation at the time of the exposure by the laser beam.

In the event that the photographic image is entered through the small type of recording medium 163 shown in FIG. 3 on which the photographic image photographed by a digital camera and the like is recorded, but not reading with the scanner section 110 the photographic image recorded on a photographic film, photographic image data is fed via the small type of recording medium drive 162 to the computer circuit section 170, and the photographic image is displayed on the CRT display section 130 shown in FIG. 1. Also in the event that the photographic image data is fed via the image interface 175 to the image correcting processing substrate 190, in a similar fashion to a case where the photographic image is read from the photographic film, when an operator designates image obtaining condition such as a print magnification, information representative of the image obtaining condition according to the designated image obtaining condition is transmitted to the image correcting processing substrate 190. And the photographic image is fed to the image correcting processing substrate 190 and is subjected to various sorts of correcting processing. Correcting image after the correcting processing is transmitted to the image output machine 200.

Next, there will be explained an arrangement of the image output machine 200 and a series of procedures in which the photographic image fed to the image output machine 200 is printed into a photograph.

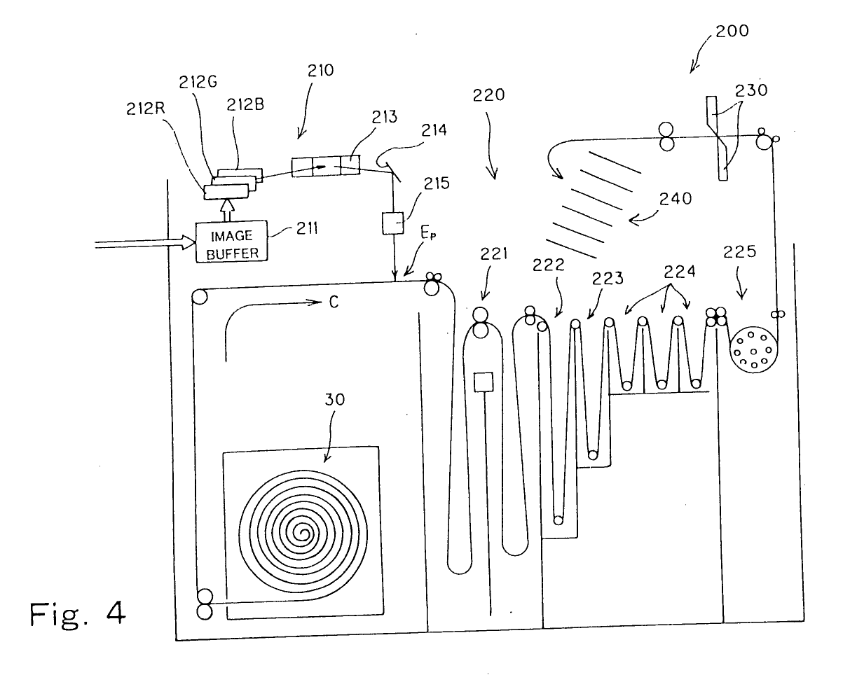

FIG. 4 is a typical illustration of an internal structure of the image output machine 200.

Inside of the image output machine 200, there is mounted an unexposed long photographic paper 30 which is wound. The photographic paper 30 is lead out via the laser printer section 210 and further via the processor section 220 to a sorter 240 with being cut one frame by one frame by a cutter 230.

The image, which is outputted from the image correcting processing substrate 190 of the image input machine 100 and is transmitted to the image output machine 200, is temporarily stored in an image buffer 211.

The laser printer section 210 is provided with three laser light sources 212R, 212G and 212B, which emit laser lights of colors of red (R), green (G) and blue (B), respectively. The laser light sources 212R, 212G and 212B are driven in accordance with the color separation images of colors of red (R), green (G) and blue (B) stored in the image buffer 211, respectively, so that the laser light sources 212R, 212G and 212B emit laser lights modulated in accordance with the driving. The laser lights thus emitted are repeatedly reflected and polarized by a rotary polyhedral mirror 213, and are reflected by a mirror 214, and further pass through an fθ lens 215 for controlling a spot size on the photographic paper 30, and finally repeatedly scan the photographic paper 30 at an exposure section Ep in a direction perpendicular with respect to the paper surface of FIG. 4. While the photographic paper 30 is scanned, the photographic paper 30 is carried in a direction of an arrow C, so that an image is exposed on the photographic paper 30.

The photographic paper 30 after the exposure is carried to the processor section 220 wherein first in a reservoir section 221, a carrying speed control of the photographic paper 30 is carried out, in a developing vessel 222, a color developing is carried out, in a fixing vessel 223, a bleaching fusing is carried out, in a rinse vessel 224, a rinse processing is carried out, in a drying section 225, the photographic paper 30 is dried, and finally the photographic paper 30 is cut by the cutter 230 one frame by one frame and stacked in the sorter 240.

The image data obtained in the image-input machine 100 is printed into a photograph by the image output machine 200 in the manner as mentioned above.

Hereinafter, there will be explained processing to be carried out in the image correcting processing substrate 190.

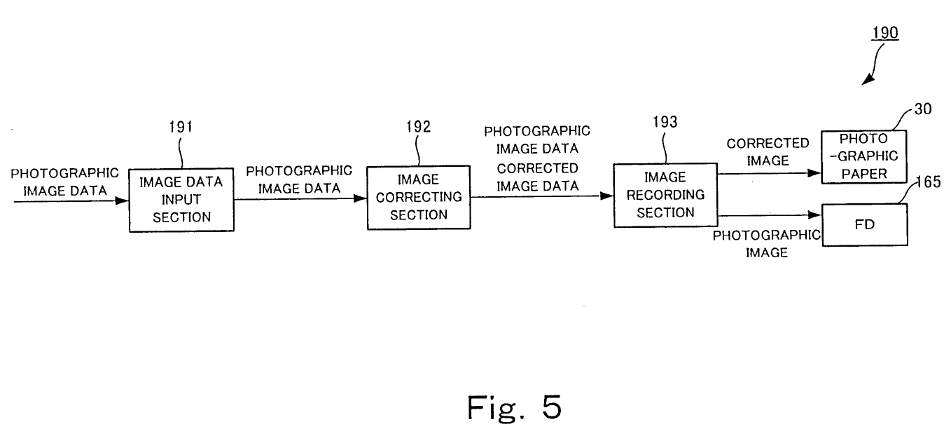

FIG. 5 is a functional block diagram of an image correcting processing substrate 190. Hereinafter, there will be explained a series of processing to be carried out in the image correcting processing substrate 190 using FIG. 5.

The photographic image data, which is obtained in the scanner section 110 of the image input machine 100 shown in FIG. 1, or the photographic image data, which is recorded on the small type of recording medium 163 shown in FIG. 3, is fed via the image interface 175 to the image data input section 191 shown in FIG. 5. The photographic image data thus entered is transmitted to the image correcting section 192.

The image correcting section 192 applies a predetermined image correcting processing to the photographic image data transmitted from the image data input section 191 to create corrected image data. According to the present embodiment, as the predetermined image correcting processing, there will be explained a red-eye correcting processing in which red eyes of a person included in a photographic image are corrected.

The red-eye is a phenomenon in which when a person or the like is photographed through flashing in the dark place, a strong flash light is projected onto the capillary of the eyeground and reflected on the capillary in the state that the pupil of the eye is opened, and as a result, the color of the person's eyes photographed in the photographic image becomes red.

In order to correct the red-eye, first, a position of an image portion of the red-eye of a photographic image is detected based on a color of the image portion constituting the photographic image represented by the photographic image data and geometry of the image portion. As a method of detecting the red-eye, the conventional method can be used.

When the position of the image portion of the red-eye is detected, then color and brightness of the image portion of the red-eye are detected. Thus, chroma or saturation of the image portion of the red-eye of the photographic image is decreased to a predetermined value so that color and brightness of the image portion of the red-eye are corrected into color and brightness equivalent to color and brightness of eyes of the general person, which are preferable as a photograph.

The corrected image data, which is subjected to the series of red-eye correcting processing, and the photographic image data, which is not subjected to the red-eye correcting processing, are transmitted together to the image recording section 193

The image recording section 193 transmits, of the image data transmitted from the image correcting section 192, the corrected image data, which is subjected to the red-eye correcting processing, to the image output machine 200 shown in FIG. 1, and transmits the photographic image data, which is not subjected to the red-eye correcting processing, to the FD 165. The FD 165 records the photographic image data. The image output machine 200 receives the corrected image data and prints the corrected image represented by the corrected image data on the photographic paper 30. The photographic paper 30 corresponds to an example of the first external media referred to in the present invention. The FD 165 corresponds to an example of the second external media referred to in the present invention.

For example, in the event that a customer, who requests a photographic print of a photographic image, feels that the corrected image, which is subjected to the red-eye correcting processing, recorded on a photograph, is not preferable, the customer may use a personal computer and the like to confirm the photographic image represented by the photographic image data recorded on the FD 165 and prints the photographic image on a photographic paper. In this manner, it is possible to confirm the corrected image through the photograph and also possible to reproduce the photographic image from the photographic image data recorded on the FD 165.

With the above, there will be terminated the explanation of the first embodiment of the image recording apparatus of the present invention including the image correcting processing substrate 190 in which a corrected image is printed into a photograph and a photographic image is recorded onto the FD 165. And next, there will be explained the second embodiment of the image recording apparatus of the present invention. The image recording apparatus of the present invention according to the second embodiment has the same structure as the first embodiment shown in FIG. 1 to FIG. 3, but input and output data are different from those of the first embodiment. Hereinafter, there will be explained different points from the first embodiment.

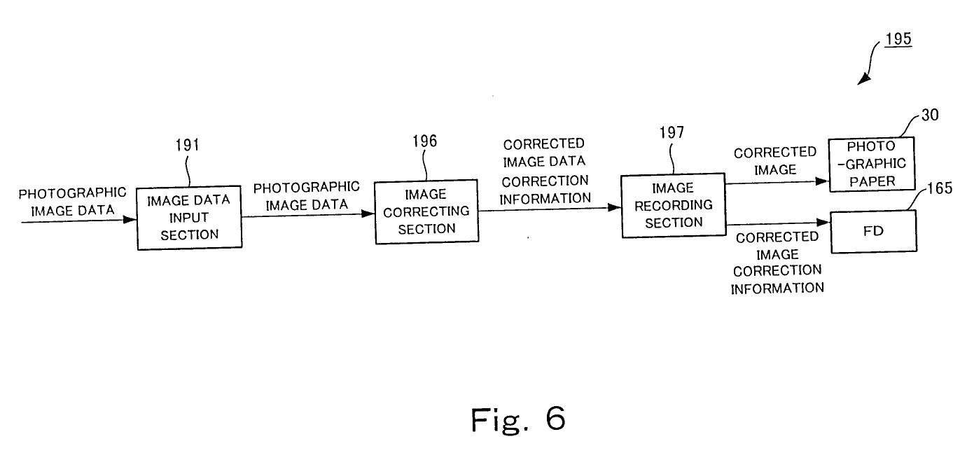

FIG. 6 is a functional block diagram of an image correcting processing substrate 195. Hereinafter, in a similar fashion to the first embodiment, there will be explained a series of processing to be carried out in the image correcting processing substrate 195 using FIG. 6.

An image correcting section 196 shown in FIG. 6 applies a red-eye correcting processing to the photographic image data transmitted from the image data input section 191 to create corrected image data, in a similar fashion to that of the image correcting section 192 of the first embodiment shown in FIG. 5. However, while the image correcting section 192 of FIG. 5 transmits the photographic image data and the corrected image data to the image recording section 193, the image correcting section 196 of the present embodiment transmits to an image recording section 197 the corrected image data and correction information for converting the corrected image data to the original photographic image data. According to the present embodiment, the correcting processing is the red-eye correcting processing. And as the correction information, it corresponds to the positional information of the red-eye and information of color and brightness before correction of the red-eye, as mentioned above in connection with the first embodiment.

The image recording section 197 transmits the corrected image data transmitted from the image correcting section 196 to the image output machine 200 in a similar fashion to that of the image recording section 193 of the first embodiment. The image output machine 200 prints the corrected image represented by the corrected image data on the photographic paper 30. The image recording section 197 transmits to the FD 165 corrected image data in which the correction information transmitted from the image correcting section 196 is added to the header of the corrected image data, different from the image recording section 193.

In the event that a customer, who requests a photographic print of a photographic image, feels that the corrected image recorded on a photograph, is not preferable, the customer may use the correction information added to the header of the corrected image data recorded on the FD 165 to change color and brightness of the image portion of the position of the red-eye of the corrected image to the color and brightness before correction, and thereby restoring the corrected image data to the photographic image data. Accordingly, it is possible to confirm the corrected image through the photograph and also possible to reproduce the photographic image through conversion of the corrected image data recorded on the FD 165 into the photographic image data.

While the above explanation has been made as to a photographic digital printer in which the corrected image and the original image are recorded onto the photographic paper and the FD, respectively, it is acceptable that the image recording apparatus of the present invention is concerned with one in which the corrected image and the original image are recorded onto the respective photographic papers, for instance. That is, according to the image recording apparatus of the present invention, it is acceptable that the first external media and the second external media, which record the corrected image and the original image, respectively, are the same sort of media.

Further, while the above explanation has been made as to a photographic digital printer in which the first external media and the second external media, which record the corrected image and the original image, respectively, are the predetermined ones, there is no need that those external media are determined beforehand. And according to the image recording apparatus of the present invention, it is acceptable that an operator may designate the first external media and the second external media, for example, using a handler such as a mouse.

Furthermore, while the above explanation has been made as to a photographic digital printer in which as an example of a correcting processing applied in the image correcting section referred to in the present invention, the red-eye correcting processing is carried out, the correcting processing is not restricted to the red-eye correcting processing. And according to the image recording apparatus of the present invention, it is acceptable that the image correcting section referred to in the present invention performs, for example, a processing for correcting images of a gold-eye and a closed-eye, a processing for correcting colors of the sky and the skin into preferable colors, and a tone correcting processing.

Still further, while the above explanation has been made as to an example in which an image recording apparatus of the present invention is applied to a photographic digital printer, any one is acceptable, as the image recording apparatus, which records corrected image wherein a predetermined correcting processing is applied to an original image, and it is acceptable that the image recording apparatus of the present invention is applicable to an apparatus other than the photographic digital printer.

As mentioned above, according to the present invention, it is possible to provide an image recording apparatus capable of obtaining a record reproducible in an original image in the event that the original image is recorded through application of an image correcting processing thereto.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. An image recording apparatus:
an image data input section that enters image data representative of an original image;
an image correcting section that applies a predetermined correcting processing to the original image represented by the image data entered through the image data input section to create corrected image; and
an image recording section that records the corrected image subjected to the correcting processing in the image correcting section onto a first external media for recording an image in form of at least either one of an image recording on a visual basis and a recording by image data, and records at least either one of a set of image and information capable of reproducing the original image and the original image a second external media for recording an image in form of at least either one of an image recording on a visual basis and a recording by image data.

2. An image recording apparatus according to claim 1, wherein the image correcting section applies a red-eye correcting processing to the original image.

3. An image recording apparatus according to claim 1, wherein the image data input section enters a photographic image, and
the image recording section records the corrected image into a photographic print, and records the set of image and information onto a medium for recording digital data.

4. An image recording apparatus according to claim 1, wherein the image data input section enters a photographic image, and
the image recording section records the corrected image into a first photographic print, and records at least either one of the set of image and information and the original image into a second photographic print.
